(19) United States
(12) Patent Application Publication
(10) Pub. No.: US 2025/0321343 A1
(43) Pub. Date: Oct. 16, 2025

(54) METHODS AND SYSTEMS FOR X-RAY DETECTOR FLASH MEMORY

(71) Applicant: GE Precision Healthcare LLC, Waukesha, WI (US)

(72) Inventors: Yu Gao, Beijing (CN); Li An, Beijing (CN); Joseph J Kulak, Waukesha, WI (US)

(21) Appl. No.: 18/637,171

(22) Filed: Apr. 16, 2024

(51) Int. Cl. G01T 1/24

(52) U.S. Cl. CPC G01T 1/245

(57) ABSTRACT

Systems are provided for a controller of an X-ray detector. The controller includes a processor communicatively coupled to a distributed flash memory and configured to execute instructions for operation of the X-ray detector. The distributed flash memory includes a first flash memory which is physically distinct from a second (Nth) flash memory, wherein the first flash memory includes a loader including instructions to startup the X-ray detector.

### TECHNICAL FIELD

Embodiments of the subject matter disclosed herein relate to systems and methods for protecting flash memory of an X-ray detector

### BACKGROUND

An X-ray detector of an imaging device includes a processor such as a field programmable gate array (FPGA). The FPGA may be communicatively coupled to a non-volatile flash memory, such as serial Flash, parallel Flash, SD card or eMMC card, which stores a loader. Upon start-up of the X-ray detector, the FPGA receives boot instructions from the loader. If the loader becomes corrupted, the X-ray detector does not turn on. Conventionally, removal of the X-ray detector from the imaging device is demanded to troubleshoot and then repair the detector. An FPGA and flash memory system wherein corruption of a loader does not enable the X-ray detector and wherein the flash memory is a field replaceable unit may decrease a downtime of the imaging device when the loader is corrupted in addition to decreasing a cost of repair.

### BRIEF DESCRIPTION

In one embodiment, a controller of an X-ray detector comprises a processor configured to execute instructions for operation of the X-ray detector, a distributed flash memory communicatively coupled to the processor comprising a first flash memory and a second flash memory, the first flash memory physically distinct from the second flash memory, wherein the first flash memory includes a loader including instructions to startup the X-ray detector.

It should be understood that the brief description above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE DRAWINGS

The present invention will be better understood from reading the following description of non-limiting embodiments, with reference to the attached drawings, herein below:

FIG. 1 shows a block diagram of an X-ray imaging system.

FIG. 2 shows an example of the X-ray imaging system configured as a digital mammography system.

FIG. 3 shows a block schematic diagram of a flash memory and field-programmable gate array (FPGA) of an X-ray detector of the prior art in active serial and passive serial configurations.

FIG. 4 shows a block schematic diagram of a distributed flash memory and FPGA of an X-ray detector in an active serial configuration.

FIG. 5 shows a block schematic diagram of a duplicate flash memory and FPGA of an X-ray detector in a passive serial configuration.

FIG. 6 shows a block schematic diagram of a distributed flash memory and FPGA of an X-ray detector including an active serial and passive serial configuration.

FIG. 7 shows block schematic diagrams of flash memory and FPGA of an X-ray detector in an active serial configuration and including a joint test action group (JTAG) interface.

FIG. 8 shows an example of a field replaceable flash memory board of an X-ray detector in an active serial configuration.

FIG. 9 shows an example of field replaceable flash memory board of an X-ray detector in a passive serial configuration.

FIG. 10 shows a flowchart of an example of a method of X-ray detector troubleshooting and repair for an X-ray detector including distributed flash memory.

### DETAILED DESCRIPTION

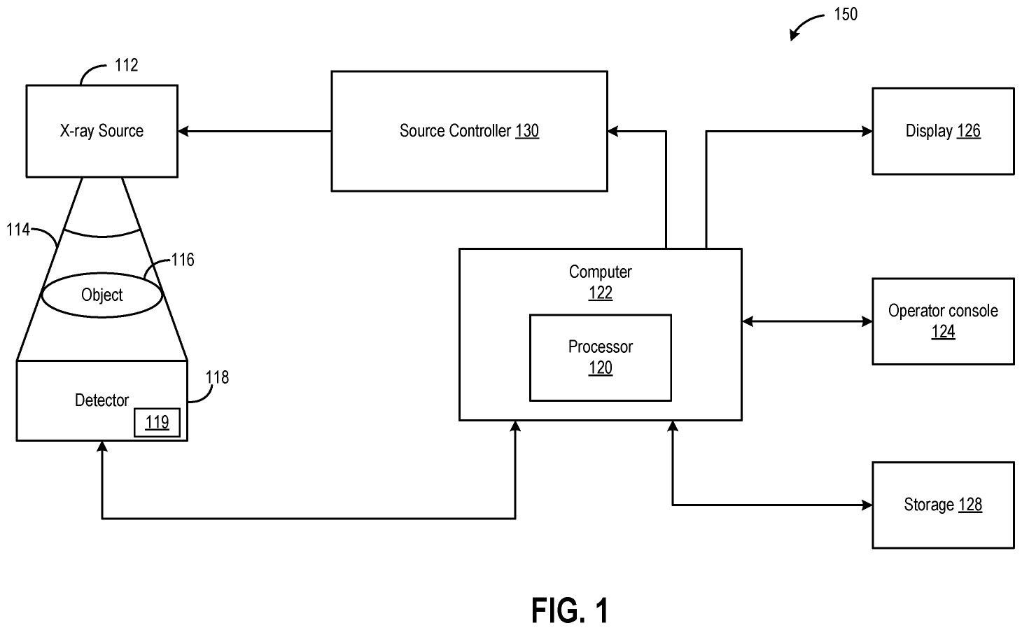

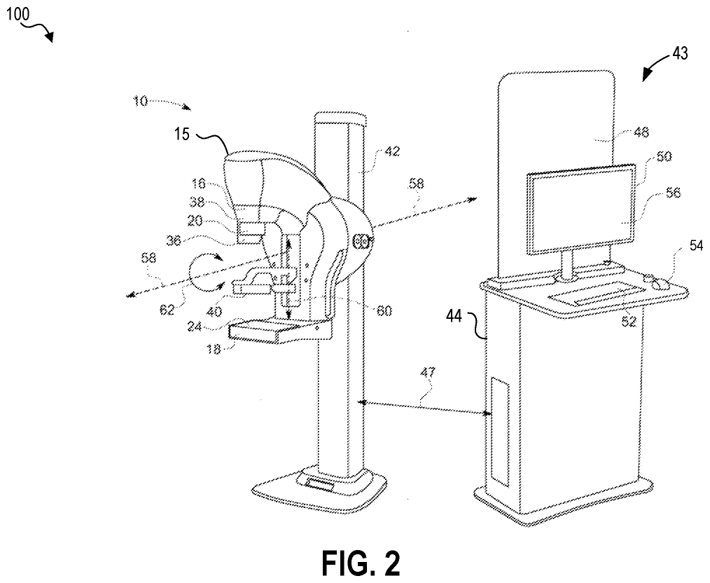

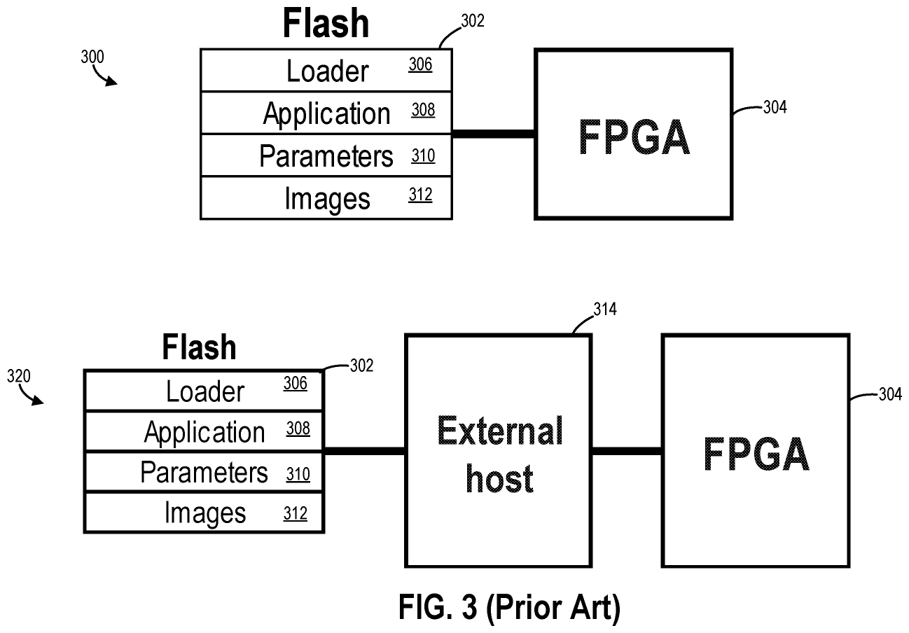

The following description relates to systems and methods for a flash memory of an X-ray detector of an imaging system. A block diagram of an example of the X-ray imaging system is shown in FIG. 1. In some examples, the X-ray imaging system may be configured as a digital mammography system, as shown in FIG. 2. The methods and systems described herein are not limited to digital mammography and may also be used in conjunction with other X-ray imaging systems and/or other systems including flash memory enabled processors. Herein, a system including a non-volatile memory communicatively coupled to a processor is referred to as a controller. The X-ray detector includes a controller comprised of a processor, such as a field-programmable gate array (FPGA) communicatively coupled to a non-volatile flash memory, which stores loading instructions (e.g., a loader) to boot the FPGA in addition to other applications, imaging parameters, and images. Block diagrams of conventional FPGA and flash memory systems in active serial and passive serial configurations are shown in FIG. 3. Herein passive serial configuration refers to a passive serial configuration or a fast passive parallel configuration. Both passive serial and fast passive parallel configurations use an external host (e.g., a complex programmable logic device (CPLD) or a microcontroller) to communicatively couple flash memory to the processor. If the loader portion of the flash memory is corrupted the detector will not boot and the detector is non-functional (e.g., “bricked”), thereby preventing both operation of the imaging system in addition to any troubleshooting of the detector until the detector is removed from the imaging system and returned to the manufacturer for replacement.

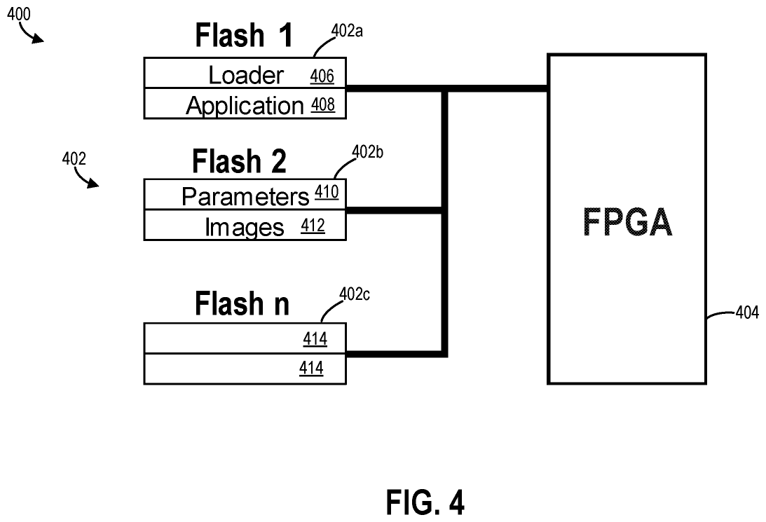

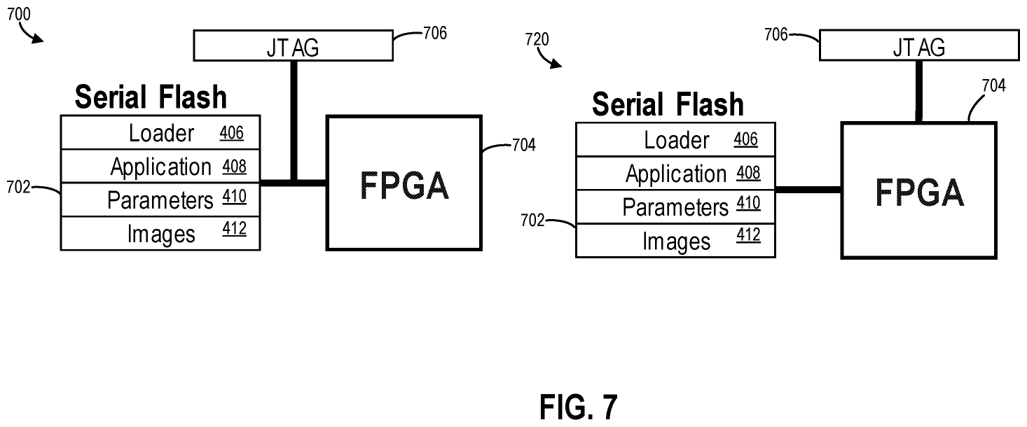

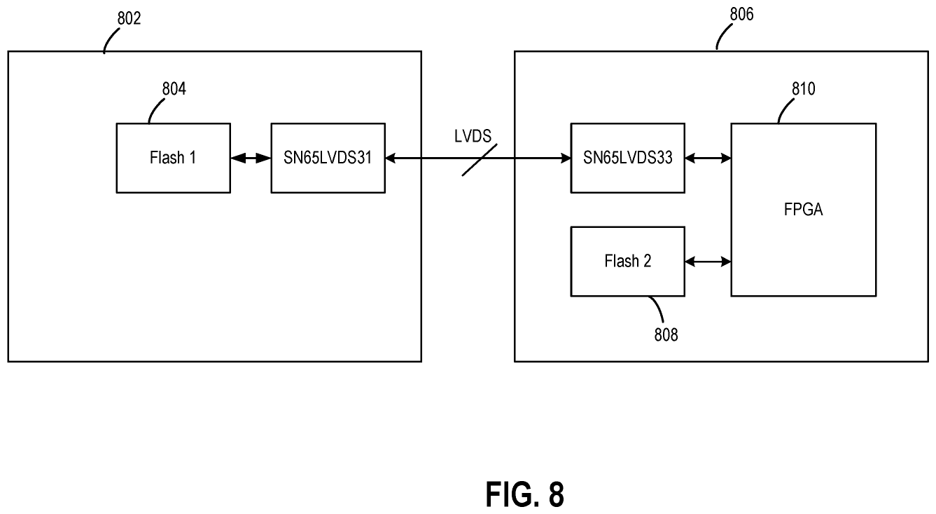

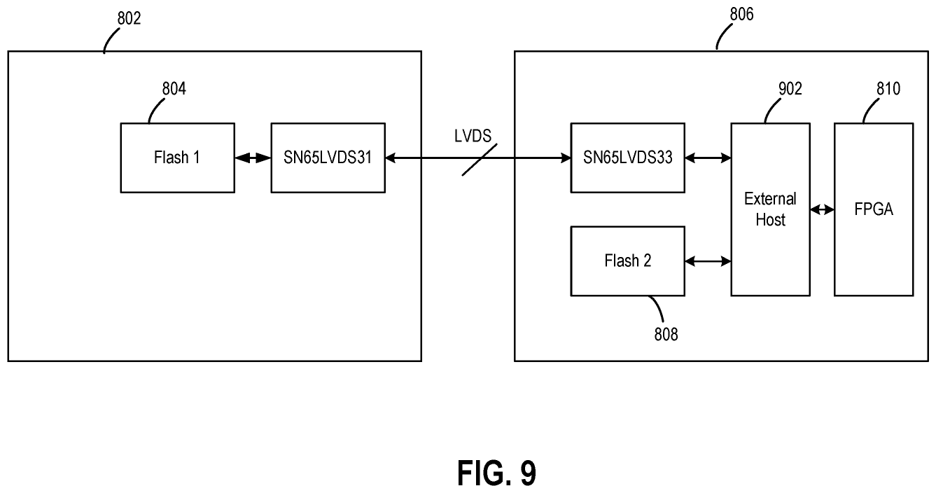

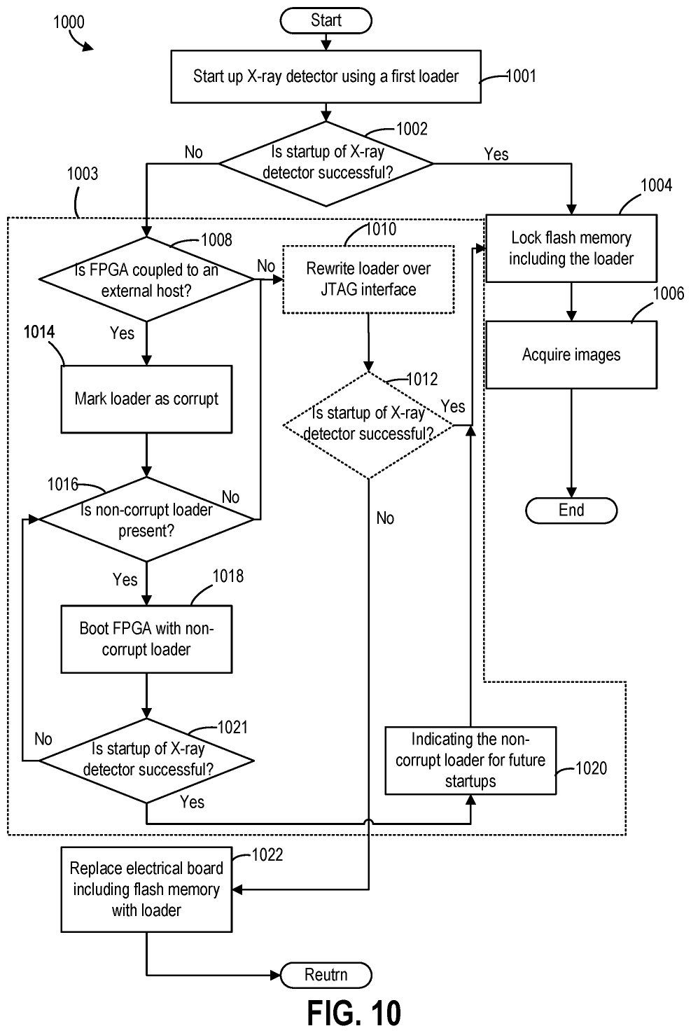

A distributed flash memory includes multiple flash devices communicatively coupled to the FPGA. The distributed flash memory may protect the loader in addition to creating redundancy. Examples of distributed flash memory in an active serial configuration, a passive serial configuration, and a combination of the two are shown in FIGS. 4-6. Additionally, or alternatively troubleshooting and field service of an X-ray detector may be more efficient. For example, a JTAG interface may be included coupled to the FPGA and flash memory as shown in FIG. 7. Further, a board including the flash memory may be configured as a field replaceable unit. An example of a field replaceable flash memory in active serial and passive serial configurations are shown in FIGS. 8-9. A method of operating an X-ray detector including a field serviceable distributed flash memory is shown in FIG. 10.

Turning now to FIG. 1, a block diagram is shown of an exemplary non-limiting embodiment of an imaging system 150 configured both to acquire original image data and to process the image data for display and/or analysis in accordance with exemplary embodiments. It will be appreciated that various embodiments are applicable to numerous X-ray imaging systems implementing an X-ray detector including a processor coupled to flash memory, such as X-ray radiography (RAD) imaging systems, X-ray mammography imaging systems, fluoroscopic imaging systems, tomographic imaging systems, or CT imaging systems. The following discussion of the imaging system 150 is merely an example of one such implementation and is not intended to be limiting in terms of modality.

As shown in FIG. 1, imaging system 150 includes an X-ray tube or source 112 configured to project a beam of X-rays 114 through an object 116. The object 116 may include a human subject, pieces of baggage, or other objects desired to be scanned. The source 112 may be conventional X-ray tubes producing X-rays 114 having a spectrum of energies that range, typically, from thirty (30) keV to two hundred (200) keV. The X-rays 114 pass through the object 16 and, after being attenuated, impinge upon a detector assembly 118. Each detector module in the detector assembly 118 produces an analog electrical signal that represents the intensity of an impinging X-ray beam, and hence the attenuated beam, as it passes through the object 116. In one embodiment, detector assembly 118 is a scintillator based detector assembly, however, it is also envisioned that direct-conversion type detectors (e.g., CdTe, CZT, Si detectors, etc.) may also be implemented. The detector assembly 118 includes an X-ray detector controller 119 including a processor, such as an FPGA, coupled to flash memory as described further herein with respect to FIGS. 4-9. The X-ray detector controller 119 may store instructions for starting up the X-ray detector as well as instructions for running the X-ray detector and may further store some images during operation of imaging system 110.

A processor 120 receives the signals from the detector assembly 118 and generates an image corresponding to the object 116 being scanned. The processor 120 of the computer 122 may be communicatively coupled to the processor the X-ray detector controller 119. A computer 122 communicates with the processor 120 to enable an operator, using an operator console 124, to control the scanning parameters and to view the generated image. That is, the operator console 124 includes some form of operator interface, such as a keyboard, mouse, voice activated controller, or any other suitable input apparatus that allows an operator to control the imaging system 150 and view the reconstructed image or other data from the computer 122 on a display unit 126. Additionally, the console 24 allows an operator to store the generated image in a storage device 128 which may include hard drives, floppy discs, compact discs, etc. The operator may also use the console 124 to provide commands and instructions to the computer 22 for controlling a source controller 130 that provides power and timing signals to the X-ray source 112.

Referring to FIG. 2, a digital mammography system 100 including an X-ray system 10 for performing a mammography procedure is shown, according to an embodiment of the disclosure. The X-ray system 10 may be an example of imaging system 150 described above with respect to FIG. 1.

The X-ray system 10 includes a support structure 42, to which a radiation source 16, a radiation detector 18, and a collimator 20 are attached. Radiation source 16 may be similar to X-ray source 112 of FIG. 1 and radiation detector 18 may be similar to detector 118 of FIG. 1. The radiation source 16 is housed within a gantry 15 that is movably coupled to the support structure 42. In particular, the gantry 15 may be mounted to the support structure 42 such that the gantry 15 including the radiation source 16 can rotate around an axis 58 in relation to the radiation detector 18. An angular range of rotation of the gantry 15 housing the radiation source 16 indicates a rotation up to a desired degree in either direction about the axis 58. For example, the angular range of rotation of the radiation source 16 may be −θ to +θ, where θ may be such that the angular range is a limited angle range, less than 360 degrees. An exemplary X-ray system may have an angular range of ±11 degrees, which may allow rotation of the gantry (that is rotation of the radiation source) from −11 degrees to +11 degrees about an axis of rotation of the gantry. The angular range may vary depending on the manufacturing specifications. The angular range for digital mammography systems may be approximately ±11 degrees to ±60 degrees, depending on the manufacturing specifications.

The radiation source 16 is directed toward a volume or object to be imaged and is configured to emit radiation rays at desired times to acquire one or more images. The radiation detector 18 is configured to receive the radiation rays via a surface 24. The detector 18 may be any one of a variety of different detectors, such as an X-ray detector, digital radiography detector, or flat panel detector. The X-ray detector may be similar to X-ray detector 118 of FIG. 1 and may include an X-ray controller including flash memory coupled to a processor as described further herein with respect to FIGS. 4-9. The collimator 20 is disposed adjacent to the radiation source 16 and is configured to adjust an irradiated zone of a subject.

In some embodiments, the system 10 may further include a patient shield 36 mounted to the radiation source 16 via face shield rails 38 such that a patient's body part (e.g., head) is not directly under the radiation. The system 10 may further include a compression paddle 40, which may be movable upward and downward in relation to the support structure along a vertical axis 60. Thus, the compression paddle 40 may be adjusted to be positioned closer to the radiation detector 18 by moving the compression paddle 40 downward toward the detector 18, and a distance between the detector 18 and the compression paddle 40 may be increased by moving the compression paddle upward along the vertical axis 60 away from the detector. The movement of the compression paddle 40 may be adjusted by a user via compression paddle actuator (not shown) included in the X-ray system 10. The compression paddle 40 may hold a body part, such as a breast, in place against the surface 24 of the radiation detector 18. The compression paddle 40 may compress the body part and hold the body part still in place while optionally providing apertures to allow for insertion of a biopsy needle, such as a core needle or a vacuum assisted core needle. In this way, compression paddle 40 may be utilized to compress the body part to minimize the thickness traversed by the X-rays and to help reduce movement of the body part due to the patient moving. The X-ray system 10 may also include an object support (not shown) on which the body part may be positioned.

The digital mammography system 100 may further include a workstation 43 comprising a controller 44 including at least one processor and a memory. Controller 44 may be similar to computer 122 of FIG. 1. Controller 44 of the digital mammography system 100 may be physically separate and different from the controller of the X-ray detector, such as X-ray detector controller 119 of FIG. 1. The controller 44 may be communicatively coupled to one or more components of the X-ray system 10 including one or more of the radiation source 16, radiation detector 18, the compression paddle 40, and a biopsy device. In an embodiment, the communication between the controller and the X-ray system 10 may be via a wireless communication system. In other embodiments, the controller 44 may be in electrical communication with the one or more components of the X-ray system via a cable 47. Further, in an exemplary embodiment, as shown in FIG. 2, the controller 44 is integrated into the workstation 43. In other embodiments, the controller 44 may be integrated into one or more of the various components of the system 10 disclosed above. Further, the controller 44 may include processing circuitry that executes stored program logic and may be any one of different computers, processors, controllers, or combination thereof that are available for and compatible with the various types of equipment and devices used in the X-ray system 10.

The workstation 43 may include a radiation shield 48 that protects an operator of the system 10 from the radiation rays emitted by the radiation source 16. The workstation 43 may further include a display 50, a keyboard 52, mouse 54, and/or other appropriate user input devices that facilitate control of the system 10 via a user interface 56.

The controller 44 may adjust the operation and function of the X-ray system 10. As an example, the controller 44 may provide timing control, as to when the X-ray source 16 emits X-rays, and may further adjust how the detector 18 reads and conveys information or signals after the X-rays hit the detector 18, and how the X-ray source 16 and the detector 18 move relative to one another and relative to the body part being imaged. The controller 44 may also control how information, including images 42 and data acquired during the operation, is processed, displayed, stored, and manipulated. Various processing steps as described herein with respect to FIGS. 2, 4, 7, and 9 performed by the controller 44, may be provided by a set of instructions stored in non-transitory memory of the controller 44.

Further, as stated above, the radiation detector 18 receives the radiation rays 22 emitted by the radiation source 16. In particular, during imaging with the X-ray system, a projection image of the imaging body part may be obtained at the detector 18. In some embodiments, data, such as projection image data, received by the radiation detector 18 may be electrically and/or wirelessly communicated to the controller 44 from the radiation detector 18. The controller 44 may then reconstruct one or more scan images based on the projection image data, by implementing a reconstruction algorithm, for example. The reconstructed image may be displayed to the user on the user interface 50 via a display screen 56.

The radiation source 16, along with the radiation detector 18, forms part of the X-ray system 10 which provides X-ray imagery for the purpose of one or more of screening for abnormalities, diagnosis, dynamic imaging, and image-guided biopsy. For example, the X-ray system 10 may be operated in a mammography mode for screening for abnormalities. During mammography, a patient's breast is positioned and compressed between the detector 18 and the compression paddle 40. Thus, a volume of the X-ray system 10 between the compression paddle 40 and the detector 18 is an imaging volume. The radiation source 16 then emits radiation rays on to the compressed breast, and a projection image of the breast is formed on the detector 18. The projection image may then be reconstructed by the controller 44, and displayed on the interface 50. During mammography, the gantry 15 may be adjusted at different angles to obtain images at different orientations, such as a cranio-caudal (CC) image and a medio-lateral oblique (MLO) image. In one example, the gantry 15 may be rotated about the axis 58 while the compression paddle 40 and the detector 18 remain stationary. In other examples, the gantry 15, the compression paddle 40, and the detector 18 may be rotated as a single unit about the axis 58.

Turning now to FIG. 3, it shows examples of block diagrams of a conventional X-ray detector controller of the prior art. A block diagram of an active serial configuration 300 and a block diagram of a passive serial configuration 320 are shown. Both the active serial configuration 300 and the passive serial configuration 320 include a flash memory 302, which may be communicatively coupled to a processor of the X-ray detector controller. In an exemplary embodiment, the processor may be an FPGA 304. The flash memory 302 may be configured as non-volatile storage of instructions for operation of the X-ray detector. Instructions for the FPGA 304 may be stored in files of flash memory 302. For example, the flash memory 302 may include separate files including a loader 306 (e.g., boot loader), an application 308, a plurality of parameters 310, and an image file 312. The loader 306 may include boot (e.g., startup) instructions for the X-ray detector. Application 308 may include instructions for functional operation of the X-ray detector after booting. The plurality of parameters 310 may include image acquisition parameters for the X-ray detector according to imaging modes for different clinical applications. Image file 312 may store and read acquired images for some clinical applications. Passive serial configuration 320 further includes an external host 314. External host 314 (e.g., CPLD or microcontroller) is configured to send instructions from flash 302 to FPGA 304. For this reason, flash 302 of passive serial configuration 320 is communicatively coupled to FPGA 304 via external host 314.

Both active serial configuration 300 and passive serial configuration 320 of the prior art include a single flash memory 302 which includes the loader in addition the application, parameters, and images. In such a configuration, corruption of the loader prevents start-up of the X-ray detector and stymies any further efforts a technician to troubleshoot the X-ray detector. Further, troubleshooting in X-ray detector controllers of the prior art demands removal and replacement of the entire X-ray detector assembly. Having a distributed flash memory including plurality of flash memories and distributing and/or duplicating the instructions among the plurality of flash memories, as described below with respect to FIGS. 4-9, allows instructions to prevent corruption of the loader and additionally or alternatively providing redundancy to enable start-up in the event that corruption of a loader occurs. Additionally or alternatively, distributed and/or duplicating flash memory coupled to the processor c allows for on-site repair or replacement of the flash memory by a field technician without removing and replacing the entire X-ray detector assembly.

An example of a block diagram 400 of an X-ray controller including a distributed flash memory 402 in an active serial configuration is shown in FIG. 4. Distributed flash memory 402 may include more than one flash memory device, each flash memory device storing different applications. For example, distributed flash memory 402 may include up to N separate flash memory device. For example, a first flash memory 402a, a second flash memory 402b and an N^{th} flash memory 402c. Each flash memory of distributed flash memory 402 can be communicatively coupled to an FPGA 404. Each flash memory of distributed flash memory 402 may be physically distinct flash memory chips, which are capable of being powered on and off together or independently from each other As one example, instructions stored on first flash memory 402a may include a loader 406 and an application 408 and instructions stored on second flash memory 402b may include parameters 410 and images 412. In alternate examples, distributed flash memory 402 may include a separate flash memory for each of the loader 406, application 408, parameters 410, and images 412, and additional flash memories for any other instructions demanded for the detector. In some examples, distributed flash memory 402 may include multiple flash devices, each include a separate copy of instructions, such as separate copies of loader 406.

In some examples a flash memory such as first flash memory 402a may include instructions that are not adjusted or demanded for storage of additional information during an imaging procedure, such as loader 406 and/or application 408. Further, first flash memory 402a may not include instructions that are adjusted or be used for storage such as parameters 410 and images 412. As one example, the first flash memory 402a including loader 406 and/or application 408 can be write-protected by enabling the delegated pin. Additionally or alternatively the first flash memory 402a may be locked to prevent overwriting instructions by firmware or software design of FPGA 404. In such an example, a flash memory such as second flash memory 402b including instructions and information which may be modified or updated to store additional information during an imaging procure, such as parameters 410 and images 412 may not include write protection and firmware or software design of the FPGA 404 may include instructions to not lock second flash memory 402b which may be configured to both be read and written by FPGA 404 after startup of the X-ray detector. Further second flash memory 402b may not include loader 406. In this way some modes of corruption of instructions (e.g., by user error) of loader 406 may be prevented. Additionally or alternatively, instructions in a flash memory unit of distributed flash memory 402 or included in the firmware and/or software design of FPGA 404 may include to de-energize the flash memory including the loader 406 (e.g., the first flash memory 402a), when instructions from the loader are not demanded. For example, first flash memory 402a may be de-energized after start-up of the detector and reading of any instructions stored in application 408. In further examples where the first flash memory includes loader 406 and does not include other instructions, the flash memory may be de-energized immediately after start-up of the X-ray detector. First flash memory 402a may not include instructions such as parameter 410 and images 412 which may be used during imaging. In this way, de-energizing first flash memory 402a does not affect normal operation of the imaging system including the X-ray detector.

Additionally or alternatively, an N^{th} flash memory 402c of distributed flash memory 402 may include duplicates of instructions 414 stored in other flash memories of the distributed flash memory. FIG. 4 shows an example of distributed flash memory 402 coupled to FPGA 404 in an active serial configuration.

In alternate examples distributed flash memory 402 may be coupled to FPGA 404 in a passive serial configuration. In the passive serial configuration distributed flash memory 402 may be communicatively coupled to FPGA 404 via an external host (e.g., a CPLD or a microcontroller).

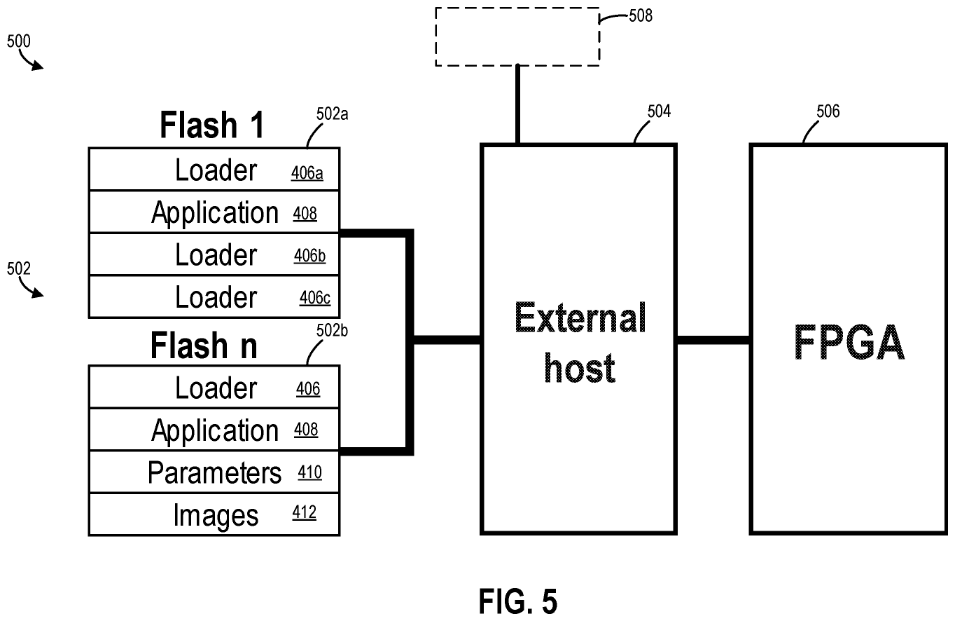

Turning now to FIG. 5, a block diagram 500 of a controller of an X-ray detector including a duplicate flash memory 502 in a passive serial configuration including an external host 504 communicatively coupling duplicate flash memory 502 to FPGA 506. In the passive serial configuration FPGA 506 may be monitored and controlled automatically by external host 504.

Duplicate flash memory 502 may include a first flash memory 502a and an N^{th} flash memory 502b. In an exemplary embodiment, first flash memory 502a may include a plurality of copies of loader 406, including first loader 406a, second loader 406b, and third loader 406c, in addition to application 408. As supplied, each copy of loader 406 may be identical. Additionally, N^{th} flash memory 502b may include a copy each of loader 406, application 408, parameters 410 and images 412.

External host 504 may store instructions as software or firmware to boot FPGA 506 from first loader 406a. External host 504 may include further instructions to then wait for confirmation from FPGA 506 that startup is successfully finished. If external host 504 does not receive the successful startup signal from FPGA 506 within a threshold amount of time, external host 504 may mark first loader 406a as corrupt and proceed to boot FPGA 506 from second loader 406b. If startup from second loader 406b is results in communication from FPGA 506 that startup is successful within the threshold amount of time, external host 504 may mark second loader 406b for use in subsequent startup requests. If startup from second loader 406b fails, external host 504 may proceed to the next available loader, such as third loader 406c in a similar fashion. If each loader 406 stored on first flash memory 502a fails, external host 504 may mark first flash memory 502a as corrupt and proceed to startup FPGA 506 from N^{th} flash memory 502b. If at least one loader 406 stored on duplicate flash memory 502 is not corrupt, FPGA may finish startup and the imaging device including the X-ray detector may proceed with normal operation. As routine maintenance, a service technician may run a diagnostic to determine if any instances of loader 406 stored on duplicate flash memory 502 are corrupted. In some examples, the service engineer may rewrite any corrupted loader with a non-corrupt version as enabled by a JTAG configurations as described further below with respect to FIG. 7. In some examples, upon determining that a flash memory or portion of a flash memory is corrupt, a part of the detector system may be replaced as described further below with respect to FIGS. 8-9. It should be appreciated that the operation and methods described herein include multiple startup operations of the same X-ray detector on repeated successive occasions, for example. The described method may include a startup in a condition with a successful startup of the X-ray detector, where responsive thereto the first flash memory of the controller is locked. Additional, the described method may further include another start in another condition with a failed startup of the X-ray detector. In response to the another startup, the X-ray detector is started up with a second loader. In this way, both conditions are required to occur across multiple, separate and distinct, starting conditions.

Additionally or alternatively, in a passive serial configuration as shown in FIG. 5 external host 504 may be configured to be communicatively coupled to an external redundant non-volatile memory device 508, such as a USB drive or an SD. The external redundant non-volatile memory device 508 may be positioned outside a housing of the X-ray detector. The external redundant non-volatile memory device 508 may also include a copy of loader 406. External host 504 may include instructions to boot FPGA from loader 406 included on the external redundant non-volatile memory device if each instance of loader 406 of internal flash memory is marked as corrupt. Further, external host 504 may include instructions to automatically rewrite a corrupt loader 406 stored on duplicate flash memory 502 with a non-corrupt backup copy of loader 406 stored on external redundant non-volatile memory device 508. A number of copies of loader 406 stored on each flash memory of duplicate flash memory 502 and on external redundant non-volatile memory device 508 may depend on a total memory capacity of the devices.

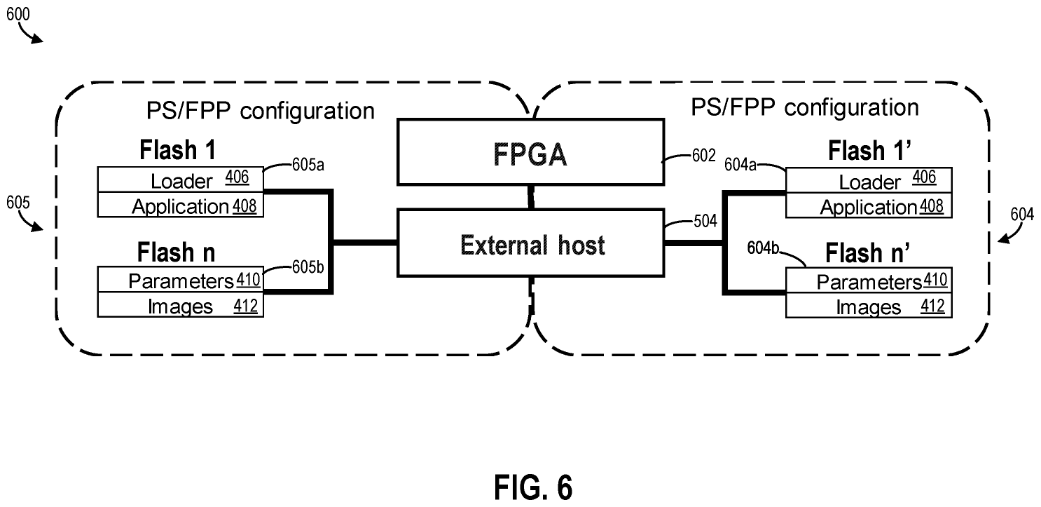

Turning now to FIG. 6, a block diagram 600 of a controller of an X-ray detector in a multiply passive configuration. FIG. 6 may include components of both passive serial or fast passive parallel block diagrams of FIG. 5. Such components are labeled the same and are not reintroduced.

The multiply passive configuration may include more than one passive serial (PS) or fast passive parallel (FPP) configuration. For example, they multiply passive configuration may include a first distributed flash memory 604 and a second distributed flash memory 605. In some examples first distributed flash memory 604 and second distributed flash memory 605 may be configured similarly to first distributed flash memory 502, including a first flash memory 604a and nth flash memory 604b and first flash memory 605a and second flash memory 605b, respectively. First flash memory 604a and first flash memory 605a each may include loader 406 and application 408 while nth flash memory 604b and nth flash memory 605b may each include parameters 410 and images 412. First distributed flash memory 604 and second distributed flash memory 605 may each be communicatively coupled to FPGA 602 via external host 504 as well. In some examples first distrusted flash memory 604 and second distributed flash memory 605 may instead be configured as a duplicate flash memory, such as duplicate flash memory 502 and may include a flash memory including multiple duplicate copies of loader 406. In the multiple configuration, FPGA 602 may be configured to default to either first distributed flash memory 604 or second distributed flash memory 605 for reading loader 406 during start up. If startup is not successful, the default flash memory may be marked as corrupt and FPGA 602 may read loader 406 from the non-default configuration. A successful startup may be determined by a communication between external host 504 and FPGA 602 within a threshold amount of time, similar to as described above with respect to the external host 504 and FPGA 506 with respect to FIG. 5. In this way, the hybrid configuration may include duplicate flash memories in a PS or FPP configuration. Additionally, the hybrid configuration of FIG. 6 may include the protective features described above with respect to FIGS. 4-5. For example, external host 504 may be coupled to an external non-volatile memory including a loader, such as external redundant non-volatile memory device 508. Additionally, the external host 504 and/or FPGA 602 may include instructions to de-energize and/or lock access to a flash memory including the loader 406 and not including parameters 410 or images 412, such as first flash memory 604a or first flash memory 605a of the PS or FPP configurations.

In addition to providing methods for protecting loader 406 and redundant instances of loader 406, a controller of an X-ray detector may be configured to communicatively couple a flash memory to an external processer as shown in FIG. 7. FIG. 7 shows a first block diagram 700 and a second block diagram 720 of a controller of an X-ray detector, each including a flash memory 702 communicatively coupled to an FPGA 704 in an active serial configuration. In alternate examples flash memory 702 may be a distributed flash memory 402 of FIG. 4. Both first block diagram 700 and second block diagram 720 include a JTAG interface 706. JTAG interface 706 may be coupled to an external processor via an FPGA download cable. The X-ray detector assembly, such as X-ray detector assembly 118 of FIG. 1 or radiation detector 18 of FIG. 2 may include a service window, allowing a service technician access to a board including JTAG interface 706. Via the JTAG interface the service technician may run diagnostics to find a corrupt instance of loader 406 and may overwrite loader 406 with a new, non-corrupted instructions. In some examples, where the flash memory includes duplicate copies of loader 406, one of which is not corrupted, the service technician may overwrite the corrupted loader with the duplicate copy stored in the same or different flash memory that is not corrupted via the JTAG interface. In some examples, the external processor coupled to the JTAG interface 706 may include an up-to-date non-corrupted copy of loader 406. Further, the FPGA may include error handling instruction to prevent an incorrect copy of the loader from being written and ensure that the loader being written is correct and up-to-date. Additionally, in examples where the X-ray detector controller has automatically bypassed a corrupt copy of loader 406, such as in the passive configuration as described above with respect to FIG. 5, as part of routine maintenance, the service technician may inspect all loaders 406 via the JTAG interface 706 and may restore any corrupt copies of loader 406.

JTAG interface 706 may be independently communicatively coupled to flash memory 702 or FPGA 704 as shown in first block diagram 700. Alternatively, JTAG interface 706 may be directly communicatively coupled to FPGA 704 and may be communicatively coupled to flash memory 702 via FPGA 704.

In some examples, one or more loaders of a distributed or duplicate flash memory, such as the flash memories discussed above with respect to FIGS. 4-7 may be physically degraded and physical replacement of the flash memory device may be demanded. For example, a stray X-ray may degrade the semiconductor material of the flash memory device and reloading of the loader as provided via a JTAG interface may not be possible. Conventional solutions for field replaceable flash memory may include affixing flash memory via a SO16 socket or using an SD card or USB device socket. However, such solutions have drawbacks for use in an X-ray detector. A physical size of the SO16 socket may be too large for incorporation into some cassette sized X-ray detectors. A USB or SD card socket are smaller, but because the X-ray detector is subject to vibrations of the rotating gantry, connection loss during image acquisition may occur.

Incorporating the flash memory into an electrical board of the X-ray detector and configuring the electrical board to be a field replaceable unit allows the flash memory to be replaced by a field technician and is both secure and a desired size for X-ray detectors. In one example, a field replaceable board may include each component of the flash memory, the FPGA, and optionally the external host and/or JTAG configuration (e.g., each component shown in the block diagrams of FIGS. 4-7.). As one example, radiation detector 18 of FIG. 2. may include a service window configured to allow the service technician access to electrical boards of the radiation detector for removal and replacement. In this way, a distance between the flash memories and the FPGA and/or external host may be decreased, compared to locating the flash memory on physically separated electrical board or external non-volatile memory.

In some examples, an electrical board including the FPGA may not be a field reproducible unit and a configuration including a first electrical board and second electrical board as shown in FIGS. 8-9 is demanded. Turning first to FIG. 8, a first electrical board 802 may include a first flash memory 804 and a second electrical board 806 may include a second flash memory 808 and an FPGA 810. First flash memory 804 may include a loader and application such as loader 406 and application 408, second flash memory 808 may include remaining instructions for the X-ray detector such as, parameters 410, and images 412. First flash memory 804 and second flash memory 808 may be configured similarly to distributed flash memory 402 of FIG. 4.

First electrical board 802 may be reversibly communicatively coupled to second electrical board 806 via two line drivers such as SN65LVDS31/33 via a low voltage differential signaling (LVDS) cable. The LVDS cable may be configured to enable controlled impedance connection between first electrical board 802 and second electrical board 806. In this way, when the loader is non-functional first electrical board 802 may be replaced with a new board including a new flash memory. The second flash memory 808 including portions used during operation of the imaging system may be remain close to FPGA 810. Coupling via the two-line connection over a LVDS cable may enable the X-ray detector to maintain high noise immunity, reduced electromagnetic interference emission and wider common-mode input tolerance even when high speed Flash access is demanded. Further, replacing an FPGA may be more expensive than a flash memory, and replacing the flash memory without demanding replacement of the FPGA as well may decrease a cost of the repair.

FIG. 8 shows an example of second electrical board 806 in an active serial configuration. Turning now to FIG. 9, it shows an example of second electrical board 806 in a PS or FPP configuration. In the AS configuration, shown in FIG. 8, first flash memory 804 may be communicatively coupled to FPGA 810 via the low voltage differential signaling (LVDS) connection and second flash memory 808 may be directly communicatively coupled to FPGA 810. In the passive serial configuration shown in FIG. 9, second electrical board 806 may further include an external host 902. First flash memory 804 may be communicatively coupled to external host 902 via the LVDS connection and second flash memory 808 may be directly communicatively coupled to external host 902. First flash memory 804 and second flash memory 808 may each be communicatively coupled to FPGA via external host 902. In examples where second electrical board 806 includes external host 902, second flash memory 808 may be configured a duplicate flash memory such as duplicate flash memory 502 of FIG. 5. In such an example, first flash memory 804 may include multiple copies of the loader. Additionally or alternatively, in examples where each copy the loader included on first flash memory 804 is corrupt, external host 902 may copy the loader from second flash memory 808 and store the new copy on first flash memory 804.

Turning now to FIG. 10, a flowchart of an example of a method 1000 for operating an X-ray detector including a controller configured to include distributed flash memory and/or duplicate flash memory as shown in FIGS. 4-9 respectively. Instructions may be at least partially stored in a non-volatile manner at a processor of the X-ray detector, such as an FPGA, as firmware or software. Additionally, instructions may be stored in a non-volatile manner at an external host communicatively coupled to the FPGA in examples where the X-ray detector controller is in a passive serial configuration.

At 1001, method 1000 includes starting the X-ray detector using a first loader. The first loader may be stored in a first flash memory communicatively coupled to the FPGA. In some examples the first flash memory may be similar to first flash memory 402a or first flash memory 502a. First flash memory may include the first loader. In some examples, the first flash memory may additionally include an application of the X-ray detector. In further examples, the first flash memory may not include parameters or images.

At 1002, method 1000 determines if startup of the X-ray detector is successful. In examples where the FPGA is communicatively coupled to an external host, the external host may determine successful startup of the FPGA by receiving a confirmation from the FPGA within a threshold amount of time. Additionally or alternatively, successful startup of the X-ray detector may be observed by an operator of the imaging device as an indication on a user interface of the X-ray imaging system that the X-ray detector is on and ready to acquire images. As a further example, the X-ray detector may signal to an operator that startup is successful using indicator lights or sounds. For example, the detector may send a flag to the processor (e.g., processor 120) of the X-ray imaging system and a display of the X-ray imaging system (e.g., display 126) may indicate to the operator an operational states (e.g., successful or unsuccessful startup) to the operator. If X-ray detector startup is successful (YES), method 1000 proceeds to 1004 and includes locking a flash memory including the loader. In some examples, locking the flash memory may include de-energizing the flash memory including the loader and/or otherwise preventing writing or reading of the flash memory including the loader. Parameters and image storage used for operating the X-ray detector during imaging may be stored on a different flash memory and locking the flash memory including the loader may be maintained while method 1000 proceeds to 1006 and includes acquiring images. Method 1000 ends.

If at 1002 it is determined that startup of X-ray detector is not successful/unsuccessful (NO) (e.g., a failed startup of the X-ray detector) method 1000 proceeds to steps indicated by box 1003. Unsuccessful startup may be indicated to the operator at the display of the X-ray system as described above and/or may be indicated by a lack of the lights/sounds that are associated with a successful startup. Steps indicated by box 1003 may be together comprise starting up the X-ray detector using a second loader. A location and steps to access the second loader may depend on a configuration and features of the X-ray detector controller. For example, the location and access to the second loader may depend on if an external host is present (e.g., if the FPGA is in active or passive serial configuration), if a JTAG interface is present, and if the first flash memory is a duplicate flash memory including more than one copy of the loader.

As part of starting an X-ray detector using a second loader, method 1000 proceeds to 1008 and includes determining if the FPGA is coupled to an external host. If the FPGA is coupled to the external host, then the X-ray detector controller may be in a parallel serial configuration. If method 1000 determines that an external host is not present (NO), then the X-ray detector controller is in an active serial configuration and method 1000 proceeds to 1010 and may include rewriting the loader using a JTAG interface if the X-ray device controller includes the JTAG interface. Rewriting the loader over the JTAG interface may be performed by a service engineer accessing the detector electrical board through a service panel and communicatively coupling the flash memory including the loader to an external processor through the JTAG interface. The loader of the x-ray detector controller may be rewritten using a duplicate copy stored in a physically separate flash memory, the physically separate flash memory also coupled to the FPGA. In alternate examples, the loader of the x-ray detector controller may be written using an up-to-date copy stored on a separate non-volatile memory coupled to the external processor. Method 1000 proceeds to 1012 and determines if rewriting the loader resulted in a successful startup of the FPGA. If startup of the FPGA is successful, method proceeds to 1004 and continues to de-energize the flash memory including the loader and acquiring images as described above. Method 1000 ends.

If at 1012, method 1000 determines that startup of the X-ray detector is not successful, method 1000 proceeds to 1022 and includes replacing the electrical board including the flash memory including the loader. Method 1000 also proceeds directly to 1022 from determining that an external host is not present at 1008 if the X-ray detector controller does not include a JTAG interface. Replacing the electrical board may be performed in response to options for starting up the X-ray detector using a second loader indicated within box 1003 are unsuccessful. The X-ray detector may include a window allowing a service engineer to remove and replace an electrical board of the X-ray detector. In some examples, replacing the electrical board may include replacing an including a flash memory including the loader and not including the FPGA. In alternate examples, replacing the electrical board may include replacing the electrical board including the FPGA and the flash memory including the loader. Method 1000 returns.

If at 1008, method 1000 determines that the FPGA is coupled to an external host, method 1000 proceeds to 1014 and includes marking the loader addressed for startup of the FPGA as being corrupt. At 1016, method 1000 determines if a non-corrupt loader is present in flash memory communicatively coupled to the FPGA via the external host. For example, the flash memory may be a duplicate or distributed flash memory and the flash memory may include multiple copies of the loader and/or the external host may be coupled to a second flash memory and/or an external non-volatile memory also including a copy of the loader. If a non-corrupt loader is present (YES), method 1000 continues to 1018 and continues to boot the FPGA with the non-corrupt loader. Method 1000 proceeds to 1021 and again determines of startup of the X-ray detector was successful. If the startup of the X-ray detector is successful (YES), method 1000 proceeds to 1020, and includes indicating the non-corrupt loader used to for successful startup for future startups and then proceeds to 1004 and includes locking the flash memory including the loader used to startup the X-ray detector, followed by acquiring images 1006. Method 1000. If at 1021, method 1000 determines that the startup of the X-ray detector was not successful (NO), method 1000 returns to 1016 and proceeds to determine if there are any other non-corrupt loaders present on the flash memories of the X-ray detector controller as described above.

If at 1016, method 1000 determines that there is no non-corrupt loader present (NO), method 1000 returns to 1010 and optionally includes rewriting the loaders of the flash memory over the JTAG interface at 1010 as described above and proceeds as described to lock the flash memory including the loader and acquire images if successful before ending or to replace the electrical board including the flash memory at 1022 if the JTAG interface is not present or if rewriting the loader over the JTAG interface does not result in X-ray detector startup before method 1000 returns.

The technical effect of method 1000 is that unsuccessful startup of an X-ray detector due to a corrupt or damaged loader of the X-ray detector controller may be prevented or diagnosed without decoupling the entire X-ray detector assembly from the imaging system. In this way, a cost of repair may be minimized and an effective downtime of the X-ray imaging system may be decreased in the even that a loader of the X-ray detector controller becomes corrupted. Further by including distributed flash memory, a flash memory including the loader may by protected by instructions to lock the loader to prevent user error causing loader corruption.

The disclosure also provides support for a controller of an X-ray detector, comprising: a processor configured to execute instructions for operation of the X-ray detector, a distributed flash memory communicatively coupled to the processor comprising a first flash memory and a second flash memory, the first flash memory physically separate from the second flash memory, wherein the first flash memory includes a loader including instructions to startup the X-ray detector. In a first example of the system, the second flash memory includes instructions used during operation of the X-ray detector. In a second example of the system, optionally including the first example, the first flash memory is coupled to the processor via a write protected pin. In a third example of the system, optionally including one or both of the first and second examples, the first flash memory and second flash memory are communicatively coupled to the processor via an external host configured to send instructions to the processor. In a fourth example of the system, optionally including one or more or each of the first through third examples, the first flash memory includes a plurality of copies of the loader. In a fifth example of the system, optionally including one or more or each of the first through fourth examples, the system further comprises: an interface configured to communicatively couple an external processor to the distributed flash memory. In a sixth example of the system, optionally including one or more or each of the first through fifth examples, the first flash memory is positioned on a first electrical board, and wherein the second flash memory and the processor are positioned on a second electrical board. In a seventh example of the system, optionally including one or more or each of the first through sixth examples, the first electrical board is coupled to the second electrical board via two line drivers and the first electrical board is configured to be replaceable without replacing the second electrical board.

The disclosure also provides support for a method for operating a controller of an X-ray detector, comprising: starting up the X-ray detector via instructions included on a first loader stored on a first flash memory and coupled to a processor of the X-ray detector, in response to successful startup of the X-ray detector, locking the first flash memory of the controller, and in response to failed startup of the X-ray detector, starting up the X-ray detector with a second loader. In a first example of the method, the controller is configured in an active serial configuration and booting the X-ray detector with the second loader includes replacing the first loader with the second loader via a JTAG interface. In a second example of the method, optionally including the first example, the first flash memory includes the second loader, and starting up the X-ray detector with the second loader is instructed by an external host communicatively coupled to the processor. In a third example of the method, optionally including one or both of the first and second examples, the method further comprises: in response to starting up the X-ray detector with the second loader, indicating via the external host the second loader is non-corrupted for future startups. In a fourth example of the method, optionally including one or more or each of the first through third examples, the second loader is included on a second flash memory, physically separate from the first flash memory, and starting up the X-ray detector with the second loader is instructed by an external host communicatively coupled to the processor. In a fifth example of the method, optionally including one or more or each of the first through fourth examples, locking the first flash memory includes de-energizing the first flash memory and/or preventing the processor from accessing the first flash memory. In a sixth example of the method, optionally including one or more or each of the first through fifth examples, the method further comprises: in response to failing to startup the X-ray detector with the second loader, replacing an electrical board of the X-ray detector, the electrical board including the first flash memory.

The disclosure also provides support for a system configured to control an X-ray detector, comprising, a field programmable gate array (FPGA), a first flash memory communicatively coupled to the FPGA, the first flash memory comprising a loader, a second flash memory communicatively coupled to the FPGA, and wherein the FPGA includes instructions to lock the first flash memory after successful startup of the X-ray detector. In a first example of the system, the first flash memory and second flash memory are coupled to the FPGA in an active serial configuration. In a second example of the system, optionally including the first example, the first flash memory and second flash memory are coupled to the FPGA in a passive serial or fast passive parallel configuration. In a third example of the system, optionally including one or both of the first and second examples, the system further comprises: a third flash memory and fourth flash memory coupled to the FPGA in an active serial configuration. In a fourth example of the system, optionally including one or more or each of the first through third examples, the system further comprises: an external redundant non-volatile memory device including the loader and coupled to the FPGA via an external host.

In alternative embodiment, the disclosure provides support for a controller of an X-ray detector, comprising: a processor configured to execute instruction for operation of the X-ray detector; and a flash memory communicatively coupled to the processor comprised of a loader, the loader including instructions to startup the X-ray detector, wherein the processor and flash memory are accessible for configuration by JTAG interface and/or the processor and flash memory are field replaceable parts.

As used herein, an element or step recited in the singular and preceded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising,” “including,” or “having” an element or a plurality of elements having a particular property may include additional such elements not having that property. The terms “including” and “in which” are used as the plain-language equivalents of the respective terms “comprising” and “wherein.” Moreover, the terms “first,” “second,” and “third,” etc. are used merely as labels, and are not intended to impose numerical requirements or a particular positional order on their objects.

FIG. 2 shows an example configuration with relative positioning of the various components. If shown directly contacting each other, or directly coupled, then such elements may be referred to as directly contacting or directly coupled, respectively, at least in one example. Similarly, elements shown contiguous or adjacent to one another may be contiguous or adjacent to each other, respectively, at least in one example. As an example, components laying in face-sharing contact with each other may be referred to as in face-sharing contact. As another example, elements positioned apart from each other with only a space there-between and no other components may be referred to as such, in at least one example. As yet another example, elements shown above/below one another, at opposite sides to one another, or to the left/right of one another may be referred to as such, relative to one another. Further, as shown in the figures, a topmost element or point of element may be referred to as a “top” of the component and a bottommost element or point of the element may be referred to as a “bottom” of the component, in at least one example. As used herein, top/bottom, upper/lower, above/below, may be relative to a vertical axis of the figures and used to describe positioning of elements of the figures relative to one another. As such, elements shown above other elements are positioned vertically above the other elements, in one example. As yet another example, shapes of the elements depicted within the figures may be referred to as having those shapes (e.g., such as being circular, straight, planar, curved, rounded, chamfered, angled, or the like). Further, elements shown intersecting one another may be referred to as intersecting elements or intersecting one another, in at least one example. Further still, an element shown within another element or shown outside of another element may be referred as such, in one example.

This written description uses examples to disclose the invention, including the best mode, and also to enable a person of ordinary skill in the relevant art to practice the invention, including making and using any devices or systems and performing any incorporated methods. The patentable scope of the invention is defined by the claims, and may include other examples that occur to those of ordinary skill in the art. Such other examples are intended to be within the scope of the claims if they have structural elements that do not differ from the literal language of the claims, or if they include equivalent structural elements with insubstantial differences from the literal languages of the claims.

1. A controller of an X-ray detector, comprising:
a processor configured to execute instructions for operation of the X-ray detector;
a distributed flash memory communicatively coupled to the processor comprising a first flash memory and a second (Nth) flash memory, the first flash memory physically distinct from the second (Nth) flash memory, wherein the first flash memory includes a loader including instructions to startup the X-ray detector.

2. The controller of claim 1, wherein the second (Nth) flash memory includes instructions used during operation of the X-ray detector.

3. The controller of claim 1, wherein the first flash memory is coupled to the processor via a write protected pin, and wherein the first flash memory is configured to be de-energized after start-up of the X-ray detector.

4. The controller of claim 1, wherein the first flash memory is configured via a JTAG interface.

5. The controller of claim 1, wherein the first flash memory and second (Nth) flash memory are communicatively coupled to the processor via an external host configured to send instructions to the processor.

6. The controller of claim 5, wherein the first flash memory and second flash memory each include a plurality of copies of the loader.

7. The controller of claim 1, further comprising an interface configured to communicatively couple an external processor to the distributed flash memory, and wherein the distributed flash memory is non-volatile.

8. The controller of claim 1, wherein the first flash memory is positioned on a first electrical board, and wherein the second (Nth) flash memory and the processor are positioned on a second electrical board.

9. The controller of claim 8, wherein the first electrical board is coupled to the second electrical board via two line drivers and the first electrical board is configured to be replaceable without replacing the second electrical board.

10. A method for operating a controller of an X-ray detector, comprising:
starting up the X-ray detector via instructions included on a first loader stored on a first flash memory and coupled to a processor of the X-ray detector;
in response to successful startup of the X-ray detector, locking the first flash memory of the controller; and
in response to failed startup of the X-ray detector, starting up the X-ray detector with a second loader.

11. The method of claim 10, wherein the controller is configured in an active serial configuration and booting the X-ray detector with the second loader includes replacing the first loader with the second loader via a JTAG interface.

12. The method of claim 10, wherein the first flash memory includes the second loader, and starting up the X-ray detector with the second loader is instructed by an external host communicatively coupled to the processor.

13. The method of claim 12, further comprising, in response to starting up the X-ray detector with the second loader, indicating via the external host the second loader is non-corrupted for future startups.

14. The method of claim 10, wherein the second loader is included on a second flash memory, physically separate from the first flash memory, and starting up the X-ray detector with the second loader is instructed by an external host communicatively coupled to the processor.

15. The method of claim 10, wherein locking the first flash memory includes de-energizing the first flash memory and/or preventing the processor from accessing the first flash memory.

16. The method of claim 10, further comprising, in response to failing to startup the X-ray detector with the second loader, replacing an electrical board of the X-ray detector, the electrical board including the first flash memory.

17. A system configured to control an X-ray detector, comprising;
a field programmable gate array (FPGA);
a first flash memory communicatively coupled to the FPGA, the first flash memory comprising a loader;
a second (Nth) flash memory communicatively coupled to the FPGA; and
wherein the FPGA includes instructions to lock the first flash memory after successful startup of the X-ray detector.

18. The system of claim 17, wherein the first flash memory and second (Nth) flash memory are coupled to the FPGA in an active serial configuration.

19. The system of claim 18, wherein the first flash memory and second (Nth) flash memory are coupled to the FPGA in a passive serial or fast passive parallel configuration.

20. The system of claim 19, further comprising an external redundant non-volatile memory device including the loader and coupled to the FPGA via an external host.
